(19) United States
(12) Patent Application Publication
(10) Pub. No.: US 2018/0276092 A1
(43) Pub. Date: Sep. 27, 2018

(54) RECOVERING USING WRITE DATA STORED BY A POWERLOSS DATA PROTECTION TECHNIQUE

(71) Applicant: HEWLETT PACKARD ENTERPRISE DEVELOPMENT LP, Houston, TX (US)

(72) Inventors: Lee Nelson, Boise, ID (US); Siamak Nazari, Fremont, CA (US)

(21) Appl. No.: 15/765,547

(22) PCT Filed: Apr. 29, 2016
(86) PCT No.: PCT/US2016/030042

§ 371 Date: Apr. 3, 2018

(51) Int. Cl. G06F 11/20; G06F 3/06

(52) U.S. Cl. CPC G06F 11/2094; G06F 3/0619; G06F 2201/82; G06F 3/0647; G06F 3/0673; G06F 3/0659

(57) ABSTRACT

In some examples, a storage system dynamically selects, in response to a determined type of power backup arrangement used in the storage system, from among different powerloss data protection techniques corresponding to different types of power backup arrangements, The different powerloss data protection techniques each is responsive to loss of power by saving write data according to a common format. In response to loss of power in the storage system, the selected powerloss data protection technique is used to store write data corresponding to write operations in the storage system according to the common format to a recovery storage medium. The storage system recovers from the loss of power in the storage system by using the write data according to the common format stored using the selected powerloss data protection technique.

### BACKGROUND

A storage system can include a persistent storage medium to store data. A persistent storage medium is a storage medium that maintains data stored in the storage medium even if power to the system is lost or removed. For improved performance, the storage system can also include a write cache to temporarily store write data (associated with a write operation) that has not yet been written to the persistent storage medium. The write operation can be in response to a request from a remote requesting device. For improved performance, the storage system can send an acknowledgement of the write request to the requesting device after the write data has been stored to the write cache, but prior to storing the write data to the persistent storage medium.

### BRIEF DESCRIPTION OF THE DRAWINGS

Some implementations of the present disclosure are described with respect to the following figures.

FIG. 1 is a flow diagram of a process of a storage system according to some examples.

FIG. 2 is a block diagram of a storage system according to some examples.

FIGS. 3 and 4 are block diagrams of different storage systems according to some examples.

FIG. 5 is a block diagram of a non-transitory storage medium that stores instructions according to some examples.

### DETAILED DESCRIPTION

A storage system can include a storage device or an arrangement of storage devices. In examples of storage systems that include multiple storage devices, the storage devices can be arranged as an array of storage devices, such as an array of disk drives or other types of storage devices, including solid state storage devices. Generally, the storage device(s) include persistent storage media.

In the ensuing discussion, reference is made to a “persistent storage medium” of a storage system, which can refer to either the persistent storage medium of one storage device, or the persistent storage media of multiple storage devices.

For improved throughput of the storage system, a write cache can be provided in the storage system. The write cache is used to temporarily store write data (as well as any metadata associated with the write data) for a write operation that is responsive to a write request received from a remote requesting device over a network. The storage system can send an acknowledgement of successful completion of the write request to the requesting device over the network, even if the write data and associated metadata for the write request have not yet been written to a persistent storage medium. By not having to wait until the write data (and any associated metadata) is written to the persistent storage medium before the acknowledgment is sent to the requesting device, the storage system can provide the acknowledgment to the requesting device more quickly to provide an appearance of faster operation of the storage system.

The write cache can be implemented with a memory, such as a dynamic random access memory (DRAM), a static random access memory (SRAM), or other type of memory, that has an access speed that is greater than an access speed of the persistent storage medium of the storage system. Generally, a DRAM or SRAM is a volatile memory that can lose data stored in the memory if power is removed from the memory. Thus, if the storage system including a write cache implemented with volatile memory were to lose power unexpectedly, then the content of the write cache can be lost, which can result in a data inconsistency condition since an acknowledgement of successful completion of a write request has already been sent to the requesting device even though write data associated with the write request has not yet been stored in the persistent storage medium of the storage system. In such a scenario, the requesting device expects the write data for the write request to be persistently stored in the storage system, even though such data is lost if the content of the write cache in the storage system is lost.

To address the issue of lost data when power is unexpectedly lost in a storage system, a power backup arrangement can be provided at the storage system. The power backup arrangement includes a backup power source and any associated component(s) that is (are) used to provide temporary power for some time duration to allow the content of a write cache to be preserved in case of loss of power to the storage system.

Different storage systems (such as different generations of storage systems or different versions of storage systems) may employ different types of power backup arrangements. For example, a first type of storage system can use a first type of power backup arrangement in which the backup power source is to supply power to a first memory (which can be volatile memory) but not to certain other components of the system, such as a processor and possibly another memory in the system. Using a backup power source to supply power to the volatile memory effectively provides a non-volatile memory (the combination of the backup power source and the volatile memory constitutes the non-volatile memory), since the backup power source can be used to temporarily provide power to the volatile memory to prevent the volatile memory from losing its data so long as the backup power source is able to continue to supply power to the volatile memory.

In some examples, the backup power source can include a battery arrangement (that includes one battery or multiple batteries). In other examples, the backup power source can include a capacitor arrangement (including a capacitor or multiple capacitors) whose charge can be used to temporarily power the volatile memory. With the first type of power backup arrangement, the backup power source (e.g. a battery arrangement or capacitor arrangement) can have a smaller power capacity that is able to supply power for a relatively short period of time. Using a smaller capacity backup power source can reduce the overall cost of a storage system as compared to the cost associated with use of a larger capacity power source that can be used to power more components and can last a longer period of time.

As further examples, a second type of storage system can include a second type of power backup arrangement, which can include a larger capacitor backup power source (e.g. a larger capacity battery arrangement or larger capacity capacitor arrangement) to supply power to a larger number of components, including a first memory (which can be implemented with volatile memory), a processor of the storage system, and possibly other components in the storage system.

Although reference is made to two different types of backup power arrangements, it is noted that in other examples, more than two different types of backup power arrangements can be selectively used in different types of storage systems.

Depending upon which type of power backup arrangement is used in a storage system, different powerless data protection techniques can be used in the storage system. A powerloss data protection technique can refer to a technique to protect against loss of data in a write cache when power to the storage system is lost. For example, a first powerloss data protection technique is used if the storage system uses the first type of power backup arrangement, while a second powerloss data protection technique is used if the storage system employs the second type of power backup arrangement. Different powerloss data protection techniques can employ different respective processes to protect data in the write cache in response to detecting loss of power to the storage system.

In scenarios where a manufacturer of storage systems can build different types of storage systems that employ respective different types of power backup arrangements, it may not be desirable to provide different storage system code (in the form of machine-readable instructions) for the different storage systems depending upon which type of power backup arrangement is employed by each specific storage system. A storage system code can refer to software or firmware (or more generally, machine-readable instructions) that manages various operations of a storage system, including saving data to a persistent storage medium, storing data in a write cache, exchanging communications with a remote requesting device, recovering from a power loss to the storage system, and so forth.

In some examples, a first storage system code can be used for storage systems that employ the first type of power backup arrangement, while a second, different storage system code can be used in a storage system that employs the second type of power backup arrangement. Having to write and maintain different storage system code for different storage systems can increase manufacturing complexity and cost.

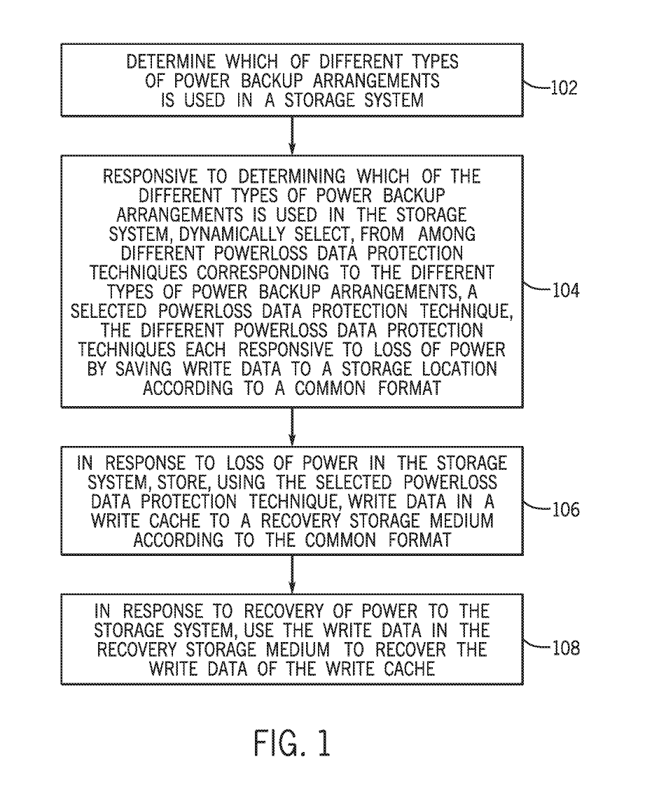

In accordance with some implementations of the present disclosure, a common storage system code that is capable of supporting any of different types of power backup arrangements can be used in storage systems. In some examples, the storage system code can perform a process according to FIG. 1. The storage system code determines (at 102) which of different types of power backup arrangements is used in the storage system. Each of the different types of power backup arrangements uses a backup power source to power a respective different combination of components in the storage system. For example, the first type of power backup arrangement uses the backup power source to power a first combination of components (including a volatile memory and associated components) in the storage system, while the second type of power backup arrangement uses the backup power source to power a second combination of components (including a volatile memory, a processor, and other components) in the second storage system. The first combination of components is different from the second combination of components.

Responsive to determining which of the different types of power backup arrangements is used in the storage system, the storage system code dynamically selects (at 104), from among different powerless data protection techniques corresponding to the different types of power backup arrangements, a selected powerloss data protection technique to use in saving write data that has not yet written to a persistent storage medium of the storage system. Such write data may have been written to the write cache, but has not yet been stored to the persistent storage medium from the write cache.

To enhance efficiency associated with using the different powerloss data protection techniques, each of the different powerloss data protection techniques is responsive to a loss of power of a storage system by performing a save of the write data according to a common format to a specified storage location (such as a recovery storage medium); in other words, the format of the saved write data as saved by each of the different powerloss data protection techniques is the same. The common format used to save the write data organizes the write data as well as metadata associated with the write data in a specific manner. For example, the write data and metadata can be divided into distinct sections or have other organizations according to the specified format.

Although reference is made to storing write data in a write cache and writing such write data from the write cache to the persistent storage medium of the storage system, it is noted that the write cache can also store metadata that is to be written to the persistent storage medium. Metadata can refer to information associated with the write data and that relates to a feature or multiple features of the storage system. For example, a feature of a storage system can include thin provisioning, in which the storage system, which can be shared by multiple requesting devices, provides an appearance of having more storage capacity than the storage system has. With thin provisioning, the storage resources of the storage system are allocated on demand, instead of up front. Metadata related to thin provisioning can include information (such as information of a file system) that keeps track of storage resources that have been allocated.

Another example feature of a storage system can include a snapshot feature, where a snapshot stores a version of data at a respective point in time. The snapshot is part of backup data that can be used to recover data of the storage system in case of data corruption or storage system error or failure. The metadata related to snapshots can track pieces of data stored in the snapshots.

In further examples, the metadata can relate to other features of the storage system.

The write data and associated metadata according to the common format can be saved to a recovery storage medium, which can be persistent in that the recovery storage medium can maintain its stored content even when power in the storage system is removed. The recovery storage medium can include a disk drive (or disk drives), a solid state drive (or solid state drives), or any other type of storage medium that can store data persistently. The recovery storage medium can be used as a staging storage region to store write data and any associated metadata during a recovery process for recovering data to the persistent storage medium after a power loss to the storage system has occurred.

In response to loss of power in the storage system, write data (and any metadata) in the write cache is stored (at 106) according to the common format using the selected powerloss data protection technique to the recovery storage medium.

In response to recovery of power in the storage system, the write data in the recovery storage medium is used (at 108) to recover the write data (and any metadata) of the write cache.

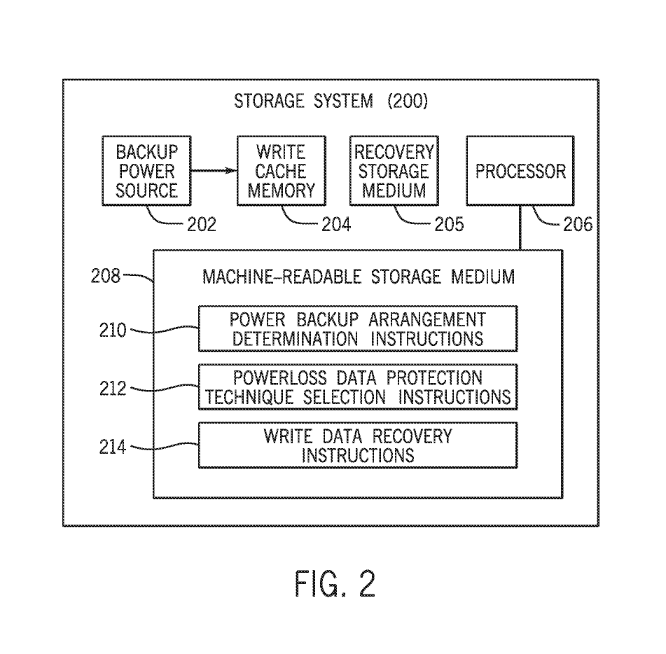

FIG. 2 is a block diagram of an example storage system 200 according to some examples. It is noted that the storage system 200 is intended to represent a generic storage system that can employ any one of the different types of power backup arrangements.

The storage system 200 includes a backup power source 202 (e.g. a battery arrangement including a battery or multiple batteries) that is able to provide power to a write cache memory 204, which can be implemented as a volatile memory. A combination of the backup power source 202 and the write cache memory 204 can be considered a non-volatile memory. In some examples, the write cache memory 204 can be implemented as a memory module that includes multiple memory devices, such as multiple DRAM devices. An example of such a memory module can be a dual inline memory module (DIMM), although other types of memory modules can be employed. In yet further examples, the write cache memory 204 can be implemented as a single standalone memory device, or as a group of memory devices arranged on a circuit board.

The storage system 200 further includes a recovery storage medium 205, in which write data in the write cache memory 204 can be saved according to the common format as discussed above for the purpose of recovering the write data (and any associated metadata) in response to loss of power to the storage system 200.

The storage system 200 also includes a processor 206. Although just one processor is shown in FIG. 2, it is noted that the storage system 200 can include multiple processors. A processor can include a microprocessor, a core of a multi-core microprocessor, a programmable integrated circuit device, a programmable gate array, or any other type of hardware processing circuit. The storage system 200 also includes a non-transitory machine-readable storage medium 208 that stores machine-readable instructions that are executable on the processor 206 (or alternatively, multiple processors).

The machine-readable instructions stored in the machine-readable storage medium 208 includes power backup arrangement determination instructions 210 to determine a given type of power backup arrangement from among different types of power backup arrangements used by the storage system 200. The different types of power backup arrangements can include a first type of power backup arrangement that uses the backup power source 202 to power the first memory 204 but not the processor 206, and a second type of power backup arrangement that uses the backup power source 202 to power the first memory 204 and the processor 206.

The machine-readable instructions can also include powerloss data protection technique selection instructions 212 that can, based on the determined given type of power backup arrangement used by the storage system, dynamically select, from among different powerloss data protection techniques corresponding to the different types of power backup arrangements, a selected powerloss data protection technique to use, in response to a loss of power to the storage system 200, in storing write data in the write cache memory 204 to the recovery storage medium 205 according to a specified format that is in common with a format used by another of the different powerloss data protection techniques in storing write data responsive to a power loss.

The machine-readable instructions further include write data recovering instructions 214 to recover the write data of the write cache memory 204 using the write data stored to the recovery storage medium according to the specified format.

The power backup arrangement determination instructions 210, the powerloss data protection technique selection instructions 212, and the write data recovery instructions 214 can be part of the storage system code discussed above that performs tasks according to FIG. 1, in some examples.

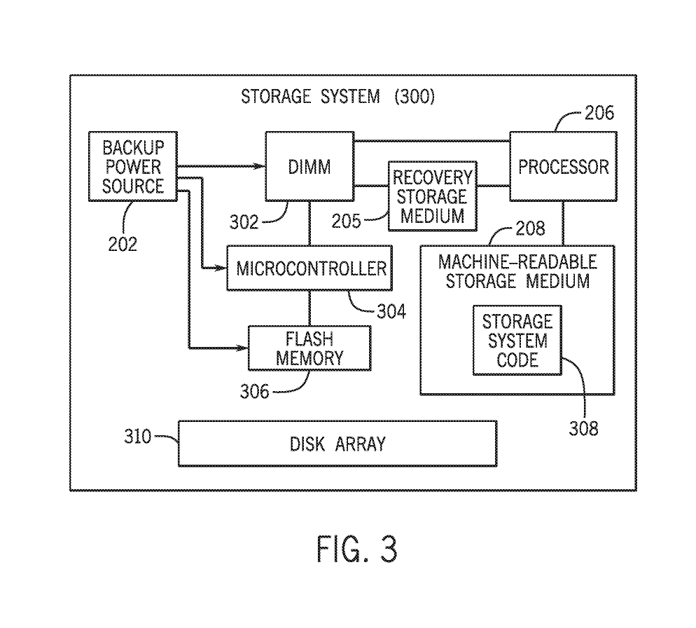

FIG. 3 is a block diagram of an example storage system 300 that employs the first type of power backup arrangement. In the example of FIG. 3, a DIMM 302 is the write cache memory 204 of FIG. 2, where the DIMM 302 can be powered by the backup power source 202. In response to a write request from a remote requesting device, write data and associated metadata are first stored into the DIMM 302, and an acknowledgment of the write request is sent to the requesting device prior to writing the write data and the associated metadata to a persistent disk array 310, which includes an array of disk drives.

In FIG. 3, a microcontroller 304 and a flash memory 306 are also powered by the backup power source 202. However, with the first type of power backup arrangement, the backup power source 202 does not supply power to the processor 206 and possibly to a second memory (not shown) that can also be a volatile memory. The microcontroller 304 includes a hardware processing circuit (or a combination of a hardware processing circuit and machine-readable instructions) that is used to transfer data between the DIMM 302 and the flash memory 306. The flash memory 306 is a non-volatile memory that is able to maintain the content of the flash memory 306 even if power is removed from the flash memory 306. In other examples, a different type of non-volatile memory 306 can be used.

The storage system 300 further includes the machine-readable storage medium 208 that stores storage system code 308. Since the storage system 300 uses the first type of power backup arrangement, the storage system code 308 executable on the processor 206 dynamically selects the first powerloss data protection technique to protect write data and associated metadata in the DIMM 302 against a power loss. In some examples, since the DIMM 302 is backed up by the backup power source 202, the first powerloss data protection technique employed by the storage system code 308 stores write data (and associated metadata) for write operations requested by a remote requesting device to the DIMM 302, but not to another memory that is not power backed by the backup power source 202.

In response to a loss of power to the storage system 300, while power from the backup power source 202 is available to the DIMM 302, the microcontroller 304, and the flash memory 306, the microcontroller 304 can automatically transfer data (including write data and associated metadata) from the DIMM 302 to the flash memory 306.

After data has been transferred from the DIMM 302 to the flash memory 306, data is safely held in the flash memory 306 until power is restored to the storage system 300. In this way, the data in the DIMM 302 would not be lost due to the loss of power to the storage system 300. The backup power source 202 can last for some specified amount of time during which the microcontroller 304 can perform the transfer of data from the DIMM 302 to the flash memory 306.

Later, in response to detecting, by the microcontroller 304 that power is restored to the storage system 300, the microcontroller 304 can transfer the data from the flash memory 306 back to the DIMM 302.

After data has been transferred from the flash memory 306 to the DIMM 302, a data recovery process can continue. For example, the data in the DIMM 302 can be saved according to the common format to the recovery storage medium 205, and the data in the recovery storage medium 205 can be processed to cause the data (including write data and metadata of the write cache) to be written to the disk array 310. During the recovery process, the metadata in the recovery storage medium 205 can be processed to determine how respective portions of write data in the recovery storage medium 205 are to be stored to recover the storage system 300 to a state prior to the power loss. For example, if redundancy such as redundant array of independent disks (RAID) redundancy is employed, then the metadata can be used to determine how write data can be saved from the recovery storage medium 205 to the disk array 310 in a manner consistent with the redundancy scheme employed. Similarly, if the write data relates to snapshots, then the metadata can specify how the write data is to be stored to the disk array 310 as respective snapshots.

FIG. 4 is a block diagram of another example storage system 400 that uses the second type of power backup arrangement, in which the backup power source 202 can be implemented with a larger battery arrangement that can be used to supply backup power to the DIMM 302 as well as to other components, including the processor 206, a second memory 402 (which can also be implemented with a volatile memory), and the recovery storage medium 205.

In examples according to FIG. 4, the write cache can include the DIMM 302 and the second memory 402, so that write data and associated metadata for write requests from remote requesting device(s) can be stored in both the DIMM 302 and the second memory 402. This is unlike the case with the storage system 300 of FIG. 3 where the write data and associated metadata for write requests have to be stored in the DIMM 302, since the backup power source 202 in the storage system 300 does not supply power to another memory.

Since the storage system 400 uses the second type of power backup arrangement, the storage system code 308 executable on the processor 206 dynamically selects the second powerloss data protection technique to use in protecting write data and associated metadata in the write cache (including the DIMM 302 and the second memory 402) against loss of power to the storage system 400.

The larger capacity backup power source 202 in the storage system 400 can provide power to more components than the smaller capacity backup power source 202 in the storage system 300 of FIG. 3. In response to a loss of power to the storage system 400, the storage system code 308 is executable on the processor 206 to transfer write data and associated metadata held in the DIMM 302 and possibly in the second memory 402 to the recovery storage medium 205. The write data and associated metadata are transferred to the recovery storage medium 205 in the common format.

Once power is restored to the storage system 400, the content of the recovery storage medium 205 can be used to recover the write data and the associated metadata for writing to the disk array 310, in the manner discussed above in connection with FIG. 3.

With the first powerless data protection technique that is used with the storage system 300 of FIG. 3, the saving of the write data and associated metadata according to the common format to the recovery storage medium 205 occurs in response to detecting that power has been recovered to the storage system 300 following a loss of power to the storage system 300.

In contrast, with the second powerloss data protection technique that is used with the storage system 400 of FIG. 4, the saving of the write data and associated metadata according to the common format to the recovery storage medium 205 occurs in response to the loss of power to the storage system 300 and prior to the backup power source 202 being depleted.

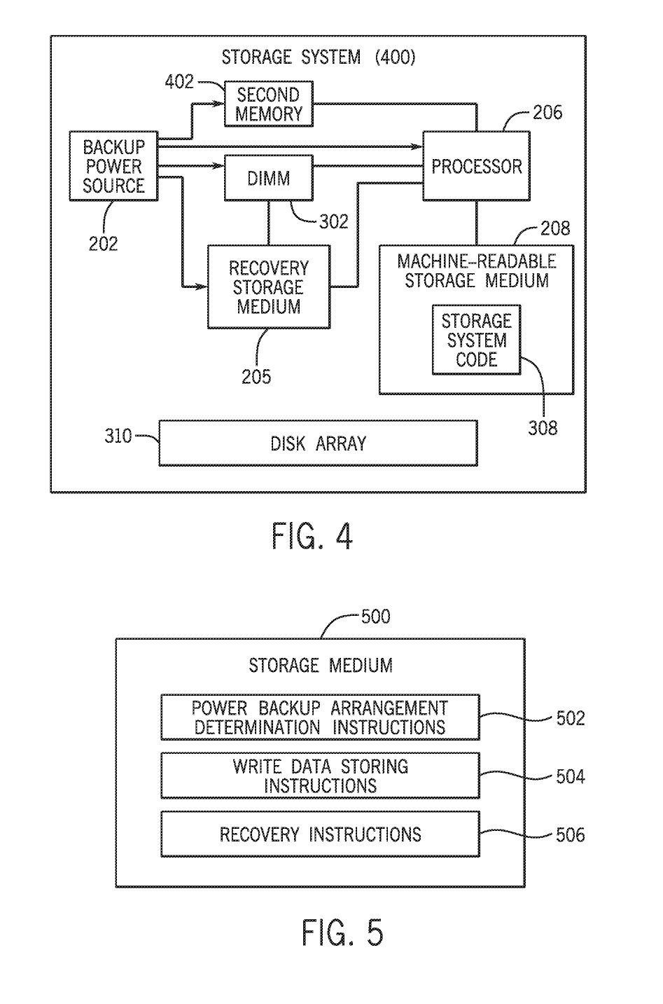

FIG. 5 is a block diagram of an example non-transitory machine-readable or computer-readable storage medium 500 that stores machine-readable instructions according to some implementations executable on a processor (or processors). The machine-readable instructions include powerloss data protection technique selection instructions 502 that are responsive to a determined type of power backup arrangement used in a storage system to dynamically select, from among different powerloss data protection techniques corresponding to different types of power backup arrangements, a selected powerloss data protection technique, the different powerloss data protection techniques each responsive to loss of power by saving write data according to a common format.

The machine-readable instructions further include write data storing instructions 504 to, in response to loss of power in the storage system, store, using the selected powerloss data protection technique, write data corresponding to write operations in the storage system according to the common format to a recovery storage medium.

The machine-readable instructions further include recovery instructions 506 to recover from the loss of power of the storage system by using the write data according to the common format stored using the selected powerloss data protection technique.

The storage medium 208 of FIG. 2, 3, or 4 or the storage medium 500 of FIG. 5 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory storage medium storing instructions that upon execution cause a storage system to:
responsive to a determined type of power backup arrangement used in the storage system, dynamically select, from among different powerloss data protection techniques corresponding to different types of power backup arrangements, a selected powerloss data protection technique, the different powerloss data protection techniques each responsive to loss of power by saving write data according to a common format;
in response to loss of power in the storage system, store, using the selected powerloss data protection technique, write data corresponding to write operations in the storage system according to the common format to a recovery storage medium; and
recover from the loss of power in the storage system by using the write data according to the common format stored using the selected powerloss data protection technique.

2. The non-transitory storage medium of claim 1, wherein the different types of power backup arrangements include a first type of power backup arrangement in which a backup power source is to supply power to a first memory but not to a processor of the storage system, and a second type of power backup arrangement in which the backup power source is to supply power to the first memory and the processor.

8. The non-transitory storage medium of claim 2, wherein the different powerloss data protection techniques comprise a first powerloss data protection technique corresponding to the first type of power backup arrangement, and a second powerloss data protection technique corresponding to the second type of power backup arrangement,
the first powerloss data protection technique saving the write data to the first memory but not to a second memory not powered by the backup power source, and
the second powerloss data protection technique saving the write data to both the first and second memories.

4. The non-transitory storage medium of claim 3, wherein if the selected powerloss data protection technique is a first powerloss data protection technique, the selected powerloss data protection technique is responsive to the loss of power of the storage system by copying the write data corresponding to the write operations from a first memory powered by the backup power source to a non-volatile memory.

5. The non-transitory storage medium of claim 4, wherein the copying of the write data corresponding to the write operations is performed by a microcontroller powered by the backup power source.

6. The non-transitory storage medium of claim 4, wherein the instructions upon execution cause the storage system to:
In response to recovery of power to the storage system;
restore the write data corresponding to the write operations from the non-volatile memory to the first memory; and
after the restoring, writing the write data corresponding to the write operations from the first memory to a recovery storage medium according to the common format; and
recover the write data corresponding to the write operations using the write data corresponding to the write operations stored in the recovery storage medium according to the common format.

7. The non-transitory storage medium of claim 3, wherein if the selected powerloss data protection technique is a second powerloss data protection technique, the selected powerloss data protection technique is responsive to the loss of power of the storage system by transferring, by a processor, the write data corresponding to the write operations from at least one memory to a recovery storage medium according to the common format,
wherein the instructions upon execution cause the storage system to, in response to recovery of power to the storage system, recover the write data corresponding to the write operations using the write data according to the common format stored in the recovery storage medium.

8. The non-transitory storage medium of claim 1, wherein the selected powerloss data protection technique is to further store metadata associated with the write data corresponding to the write operations according to the common format.

9. A method comprising:
determining, by a storage system comprising a processor, which of different types of power backup arrangements is used in the storage system;
responsive to determining which of the different types of power backup arrangements is used in the storage system, dynamically selecting, from among different powerloss data protection techniques corresponding to the different types of power backup arrangements, a selected powerloss data protection technique, the different powerloss data protection techniques each responsive to loss of power by saving write data to a storage location according to a common format;
in response to loss of power in the storage system, store, using the selected powerloss data protection technique, write data in a write cache to a recovery storage medium according to the common format, wherein the write data in the write cache has not yet been written to a persistent storage medium of the storage system; and
in response to recovery of power to the storage system, using the write data in the recovery storage medium to recover the write data of the write cache.

10. The method of claim 9, wherein the different types of power backup arrangements use a backup power source to power respective different combinations of components in the storage system.

11. The method of claim 9, further comprising, in response to the loss of power in the storage system, storing, to the recovery storage medium, the write data and metadata associated with the write data according to the common format, and wherein the recovering further uses the metadata.

12. The method of claim 9, wherein if the selected power data protection technique is a first powerloss data protection technique, the selected powerloss data protection technique stores the write data to a recovery storage medium in response to recovery of power to the storage system following loss of power to the storage system.

13. The method of claim 12, wherein if the selected power data protection technique is a second powerloss data protection technique, the selected powerloss data protection technique stores the write data to the recovery storage medium in response to loss of power to the storage system and before a backup power source is depleted.

14. The method of claim 12, wherein the selected powerloss data protection technique transfers, in response to loss of power to the storage system, the write data stored in the write cache to a non-volatile memory, and the method further comprising:
in response to recovery of power to the storage system, restore the write data of the write cache from the non-volatile memory to the write cache; and
in response to the restoring, store the write data from the write cache to the recovery storage medium.

15. A storage system comprising:
a backup power source;
a write cache memory;
a recovery storage medium;
a processor; and
a machine-readable storage medium storing instructions executable on the processor to:
determine a given type of power backup arrangement from among different types of power backup arrangements used by the storage system, a first of the different types of power backup arrangements powering the first memory but not the processor using the backup power source, and a second of the different types of power backup arrangements powering the first memory and the processor using the backup power source,
based on the given type of power backup arrangement used by the storage system, dynamically select, from among different powerloss data protection techniques corresponding to the different types of power backup arrangements, a selected powerloss data protection technique to use, in response to a loss of power to the storage system, in storing write data in the write cache memory to the recovery storage medium according to a specified format that is in common with a format used by another of the different powerloss data protection techniques in storing write data responsive to a power loss, and
recover the write data of the write cache memory using the write data stored to the recovery storage medium according to the specified format.
